(19) United States
(12) Patent Application Publication
(10) Pub. No.: US 2018/0110359 A1
(43) Pub. Date: Apr. 26, 2018

(54) SYSTEM FOR DETECTING JAMMING FOR A MACHINE FOR PRODUCING DRINKS VIA INFUSION

(71) Applicant: COMPAGNIE MEDITERRANEENNE DES CAFES, Carros (FR)

(72) Inventors: Jean-Pierre BLANC, Nice (FR); Bertrand THIBAULT, Nice (FR)

(21) Appl. No.: 15/568,269

(22) PCT Filed: Apr. 22, 2016
(86) PCT No.: PCT/EP2016/059106

§ 371 Date: Oct. 20, 2017

(30) Foreign Application Priority Data
Apr. 22, 2015 (FR) 15 53606

(51) Int. Cl. A47J 31/36; A47J 31/40; A47J 31/44; A47J 31/54; A47J 31/58; A47J 31/00

(52) U.S. Cl. CPC A47J 31/3633; A47J 31/3638; A47J 31/3628; A47J 31/405; A47J 31/002; A47J 31/4403; A47J 31/545; A47J 31/58; A47J 31/407

(57) ABSTRACT

A system for producing a drink via infusion of a package comprising a product to be infused. The system comprising: a first and a second part having relative mobility and partially defining at least one receiving assembly to receive the package before positioning in an infusion position. The first part comprises at least one support zone to contact the package to support the package in a retention position, when the first and second part are in a first relative position. When the first and second part are in a second relative position, the at least one support zone frees the passage of the package that allows the latter to reach, the infusion position. The system also comprises a detection member rigidly connected to the first part shaped in order to be stopped by a package blocked in the retention position or between the retention and infusion positions.

### TECHNICAL FIELD OF THE INVENTION

The present invention relates to a device for producing drinks via infusion of a product in the form of a package.

More particularly, it is used in the field of EXPRESSO coffee machines. It can also be used in the production of drinks from other materials such as tea.

### PRIOR ART

Numerous coffee machines now use packages also called capsules or doses that form a relatively compact assembly of product to be infused.

In general, the machines for preparing drinks comprise an infusion chamber intended to receive hot water and a package of product to be infused. The reliability of the insertion of the package and of its removal out of the infusion chamber presents numerous difficulties.

The documents WO2011147792, FR2916336 and NESTEC propose machines, the reliability of which is greater overall. This greater reliability is substantially the result of sequential operation of the machine based on a very specific number of parts and very specific kinetics.

However, in practice, it is still sometimes observed that the machine becomes jammed and prevents the preparation of the drink. The jammed package must then be manually removed by the user or even by a department dedicated to the maintenance of the machines.

There is therefore a need to make the machines for preparing drinks from a package containing a product to be infused even more reliable by reducing the risks of a package getting jammed in the machine and by facilitating their unjamming if a package becomes jammed. This is the goal of the present invention.

### SUMMARY OF THE INVENTION

For this purpose, according to the invention, there is a system for producing a drink from a package comprising a product to be infused the system comprising: two half chambers together forming an infusion chamber inside which the package is intended to be infused when it reaches an infusion position;

a first and a second part, distinct from the two half chambers, having relative mobility and partially defining at least one receiving assembly intended to receive the package before its positioning in an infusion position inside the infusion chamber.
The first part comprises at least one support zone configured to stop, when the first and second part are in a first relative position, the movement, preferably via gravity, of the package and come in contact with the package in such a way as to support the package in a retention position preventing the package from reaching the infusion position. In their first relative position, the first and second part thus together define a portion of space configured to be occupied by the package in the retention position.
When the first and second part are in a second relative position, the at least one support zone frees the passage of the package that allows the latter to reach, preferably via gravity, the infusion position.

The system further comprises a detection member rigidly connected to the first part.

According to one embodiment, the detection member is shaped in order to rest, before the first and second part reach their second relative position, against a package that is blocked in the retention position or between the retention position and the infusion position.

According to one embodiment, the detection member is shaped in order to penetrate, before the first and second part reach their second relative position, said portion of space occupied by the package positioned in the retention position.

Thus, if the detection member rests against a package, the first part thus remains blocked and does not reach the second position. The system cannot then continue the cycle of preparing the drink. In particular, it does not close by the infusion chamber and/or does not inject hot water into the infusion chamber.

Thus, it is then easy to remove the blocked package and the one introduced last in order to unjam the system.

The invention thus allows the reliability of this type of machine to be reinforced particularly significantly. In particular, it allows the cycle of preparing a drink to be interrupted very early when a previous package has remained jammed during a previous cycle. It is then much easier for the user to intervene in order to remove the jammed package and make the machine operational again.

Optionally, the invention further comprises at least one of the following optional features taken alone or in combination:

According to one embodiment, the system is configured in such a way that the detection member penetrates said portion of space configured to be occupied by the package in the retention position during the relative movement of the first and second part and before the first and second part reach their second relative position.

According to an optional embodiment, the system is configured in such a way that the detection member is located outside of or is absent from said portion of space configured to be occupied by the package in the retention position when the first and second part are in their first relative position.

According to one embodiment, the system comprises a switch configured to be actuated when the first and second part are in their second relative position and configured in such a way as to interrupt the preparation of the drink if after a predetermined time, preferably after the beginning of the relative movement of the first and second part, the switch is not actuated.

According to one embodiment, the system is configured to bring back the first and second part or allow them to be manually brought back to their first relative position if after a predetermined time after the beginning of the relative movement of the first and second part from their first position, the switch has not been actuated.

According to one embodiment, the system comprises an actuator configured to bring the two half chambers together forming the infusion chamber closer together, the system being configured to actuate the actuator in such a way as to bring the two half chambers closer together only if the first and second part are in their second relative position.

According to one embodiment, the system comprises at least one actuator allowing two half chambers forming an infusion chamber in which the package is intended to be infused when it reaches the infusion position to be mutually moved and comprising control means arranged in such a way as to prevent the operation of the actuator if the detection member of the first part rests against a package.

According to one embodiment, the system the actuator is a hydraulic cylinder associated with a pump.

According to one embodiment, the system comprises a pump configured to inject water hot water into the infusion chamber when the two half chambers are closed, the system being configured to actuate the pump only if the first part is in the second position.

According to one embodiment, the system comprises a boiler configured to supply hot water to the infusion chamber, the system being configured to deactivate the operation of the boiler if after a predetermined time the first part has not reached the second position when a cycle of preparing a drink has been started.

According to one embodiment, the system comprises an end-of-trajectory switch configured to be actuated when the first part is in the second position, the system being configured to detect that the first part is in the end-of-trajectory position preferably only when the first and second part are in their second relative position.

According to one embodiment, the system comprises a switch configured to be actuated, preferably only, when the first and second part are in their second relative position. Preferably, the first and second part reach their second relative position when the first part, mobile arrives at the end of its trajectory.

According to one embodiment, the second part comprises a bearing surface configured to maintain the package in position when the first part moves with respect to the second part. Said bearing surface thus forms a stop that opposes the movement of the package under the effect of the relative movement of the first and second part.

According to one embodiment, the second part comprises a guide element carrying the bearing surface and arranged in such a way as to guide the package during its descent via gravity in preparation for its reception on the first part.

According to one embodiment, the guide element is formed at least partly by an inner face of a hopper forming a guide for the package during its reception on the first part.

According to one embodiment, the second part comprises an opening configured to allow the passage of the detection member.

According to one embodiment, the detection member is configured to penetrate an opening arranged in the second part.

According to one embodiment, the detection member is formed by a shutter extending transversely to the direction of relative movement of the first and second part. The detection member is carried by the first part. It forms, together with the latter, a one-piece part. The detection member is formed as a single piece with the first part.

According to one embodiment, the first part is a single piece.

According to one embodiment, the at least one support zone forms a vertical stop, blocking the movement of the package under the effect of its weight.

According to one embodiment, the first part comprises at least two support zones located on either side of a median plane of the system.

The median plane of the system passes through the axis of translation if the first and second part are mobile in translation.

According to one embodiment, the first part comprises at least two support zones, for a package in its retention position, preferably located on either side of a median plane of the package when the latter is in the retention position, the distance (d1, d2) between the two support zones increasing in the direction of the rear of the first part, the front of the first part being taken in the direction of movement of the first part from the first position to the second position, the distance.

According to one embodiment, the first part has an opening between the support zones, in such a way that the package can fall via gravity through said opening between the support zones when the second part reaches the second position.

According to one embodiment, the system comprises the package and:
the distance d1 separating the two support zones at the package when the first part is in the first position is less than the dimension of the package in order to prevent the latter from passing between the two zones of supports and
the distance d2 separating the two support zones at the package when the first part is in the second position is greater than the dimension of the package in order to allow the latter to fall via gravity between the two zones of supports.

According to one embodiment, the system comprises the package and the support zones of the first part are shaped in such a way that a portion P of the height H of the package is located under its contact with the support zones when the first and second part are positioned in the first position.

According to one embodiment, the system comprises the package and the system is configured in such a way that a portion of the package is facing each of the two chamber portions in a horizontal direction when the first and second part are in the first position.

Preferably, the two support zones define a substantially horizontal plane.

According to one embodiment, P>0.15H, preferably P>0.2H, preferably P>0.3H, P and H being measured vertically.

According to one embodiment, the first part comprises, at its lower end, at least one contact zone extending vertically downward.

According to one embodiment, the system comprises the contact zone forms a solid surface extending in a substantially vertical plane, the surface area of which is greater than equal to 0.5 cm².

According to one embodiment, the system comprises a tank for packages, configured to collect the used packages after their infusion. Said at least one contact zone moves inside said tank during the movement of the first part. Thus, the system being configured in such a way that the contact zone comes into contact with a used package present in the tank when the latter is full.

According to one embodiment, which said relative mobility between the first and second part is a relative mobility in translation, preferably along a horizontal axis.

According to one embodiment, the two half chambers accept relative mobility in translation along an axis parallel to the axis of relative translation of the first and second part. According to one embodiment, the system is configured in such a way that at the end of sliding, the first part is retracted, at least partially under the second part in a vertical direction in such a way that the package can move under the effect of gravity.

Alternatively, said relative mobility between the first and second part is a relative mobility in rotation.

According to one embodiment, the first and second part are mobile and stationary, respectively, with respect to a frame of the system.

According to one embodiment, the system is configured in such a way that when the first and second part go from their first to their second relative position, the package passes via gravity from the retention position to the infusion position.

According to one embodiment, the first part is rigidly connected to the support zone configured to support the package in the retention position.

According to one embodiment, the first part is stationary with respect to the support zone configured to support the package in the retention position.

According to one embodiment, the support zone configured to support the package in the retention position is rigidly connected to the first part. The detection member is rigidly connected to the second part. Thus, the support zone and the detection member are mobile with respect to each other, preferably in translation.

According to one embodiment, in the retention position, the package is located outside of the infusion chamber.

According to one embodiment, in the retention position, the package is not located between the two half-chambers. In particular, it is not located between the two half-chambers in a direction corresponding to the direction of translation of the two half-chambers or to the median plane. The median plane of the system passes through the axis of translation if the first and second part are mobile in translation.

According to one embodiment, in the retention position, the package is not located facing the two half-chambers. In the retention position, the package is located outside of a space defined by the two half-chambers.

Said support zone is configured to receive the package in the infusion position. It forms a gravitational stop for the latter. According to one embodiment, said support zone is not located facing the two half-chambers. Said support zone is located outside of a space defined by the two half-chambers. Said support zone is not located between the two half-chambers in a direction corresponding to the direction of translation of the two half-chambers or to the median plane.

The support zone is positioned with respect to the two half-chambers in such a way that when the two half chambers are mobile with respect to each other, they cannot come in contact with a package located in the support zone.

The support zone is positioned with respect to the two half-chambers in such a way as to be outside of the trajectory followed by the two half chambers during their relative mobility.

According to one embodiment, the system is configured in such a way that in the infusion position, the package is located between the two half-chambers. In particular, it is located between the two half-chambers in a direction corresponding to the direction of translation of the two half-chambers or to the median plane.

According to one embodiment, in the infusion position, the package is located facing the two half-chambers. In the retention position, the package is located inside a space defined by the two half-chambers. The downstream closing means receive the package in the infusion position. They form a gravitational stop for the package. The downstream closing means are distinct from the support zone. They are located below the latter.

The infusion chamber is defined as the portion of space defined by the two half-chambers during their relative mobility or when they are in contact with each other in order to carry out the infusion.

According to one embodiment, the support zones of the first part form upstream closing means arranged in such a way as to selectively prevent or allow the entry of the package into the infusion chamber according to the relative position of the first part with respect to the second part.

According to one embodiment, the first part comprises a receiving element, forming downstream closing means and configured to:
when the first and second part are in their first relative position: stop the descent of the package from its retention position and maintain it in its infusion position inside an infusion chamber;
when the first and second part are in their second relative position: allow the exit of the package out of the infusion chamber.

According to one embodiment, the half chambers are arranged to be distant from or close to each other in order to close or open the chamber, respectively,

According to one embodiment, the system comprises a closing device comprising: the upstream closing means rigidly connected to the first part, downstream closing means arranged in such a way as to selectively prevent or allow the exit of the package out of the chamber.

The closing device being arranged to alternatively go:
from said first position, the closing device being arranged in such a way that in said first position: the upstream closing means prevent the entry of the package in to the chamber, the downstream closing means allow the exit of the package out of the chamber,
to a second position in which: the upstream closing means allow the entry of the package into the chamber at the end of the trajectory of the first part; the downstream closing means allow the reception of the package introduced into the chamber and prevent the exit of the latter out of the chamber.

According to one embodiment, the upstream closing means and the downstream closing means are rigidly connected.

According to one embodiment, the system comprises the package.

According to one embodiment, the first part has at least two support zones positioned in contact with the package in the position for retention of the package, the first part and the package being shaped in such a way that:
when the first and second part are in their first relative position, the support zones form a stop preventing the descent of the package via gravity, the distance separating the two support zones being less than the dimension of the package at the two support zones;
when the first and second part are in their second relative position, the support zones allow the descent of the package via gravity, the distance separating the two support zones being greater than the dimension of the package at the two support zones.

According to one embodiment, the invention relates to a machine for preparing a drink comprising a system according to any one of the combination above and a boiler configured to heat a liquid intended to infuse the package.

According to another embodiment, the invention relates to a system for producing a drink from a package comprising a product to be infused the system comprising: a first and a second part having relative mobility and partly defining at least one receiving assembly intended to receive the package before its positioning in an infusion position wherein, the first part comprises at least one support zone configured to come in contact, when the first and second part are in a first relative position, with the package in such a way as to support the package in a retention position preventing the package from reaching the infusion position;

wherein when the first and second part are in a second relative position, the at least one support zone frees the passage of the package allowing the latter to reach, preferably via gravity, the infusion position. The system comprises the package and is configured in such a way that a portion of the package is facing each of the two chamber portions in a horizontal direction when the first and second part are in the first position, that is to say, when the package is in its retention position.

### BRIEF DESCRIPTION OF THE DRAWINGS

Other features, goals and advantages of the present invention will become apparent upon reading the detailed description that follows and in view of the appended drawings given as non-limiting examples in which:

FIGS. 1a to 1g illustrate some steps of the movement of a package in a system according to the invention when no package previously inserted is blocked in the system, these steps being shown in a cross-sectional view. More specifically:

FIG. 1a illustrates a system according to a non-limiting example of the invention in which the package is in a retention position.

FIG. 1b illustrates the system of FIG. 1a in which the first part moves forward and allows the package to begin its descent via gravity towards its infusion position.

FIG. 1c illustrates the system of FIG. 1a in which the package has reached the infusion position, the infusion chamber still being open.

FIG. 1d illustrates the system of FIG. 1a in which the mobile half chamber moves towards the stationary half chamber in order to close the infusion chamber.

FIG. 1e illustrates the system of FIG. 1a which the infusion chamber is closed and the package can be infused.

FIG. 1f illustrates the system of FIG. 1a in which the mobile half chamber moves away from the stationary half chamber in order to open the infusion chamber after infusion of the package.

FIG. 1g illustrates the system of FIG. 1a in which the first part moves in order to retract the downstream closing means in order to allow the package to exit the infusion chamber via gravity.

FIGS. 2a to 2d illustrate a first part according to a non-limiting example of the present invention. More specifically, these drawings are, respectively: a front perspective view, a rear perspective view, a side view and a view of the top of the first part.

FIGS. 3a to 3d illustrate a second part according to a non-limiting example of the present invention. More specifically, these drawings are, respectively: a front perspective view, a rear perspective view, a front view and a side view of the second part.

FIGS. 4a to 4c illustrate some steps of the movement of a package in a system of FIG. 1a when a package previously inserted is blocked in the system, these steps being shown in a cross-sectional view. More specifically:

FIG. 4a illustrates the system of FIG. 1a in which a first package previously inserted into the system is blocked in the chamber and in which a second package is inserted into the system and reaches its retention position.

FIG. 4b illustrates a step in which the first part moves forward, the second package begins its descent via gravity and is blocked against the first package. This drawing also illustrates the detection member, rigidly connected to the first part, that rests against the second package. The movement of the first part is therefore stopped.

FIG. 4c illustrates a step in which the first part moves backwards in order to allow the jammed package to be removed.

FIGS. 5a to 5b are two views of a non-limiting example of a system according to the invention, in which the bearing zones of the first part allow the package to begin its descent during the forward movement of the first part before the detection member rests against the package.

### DETAILED DESCRIPTION OF THE INVENTION

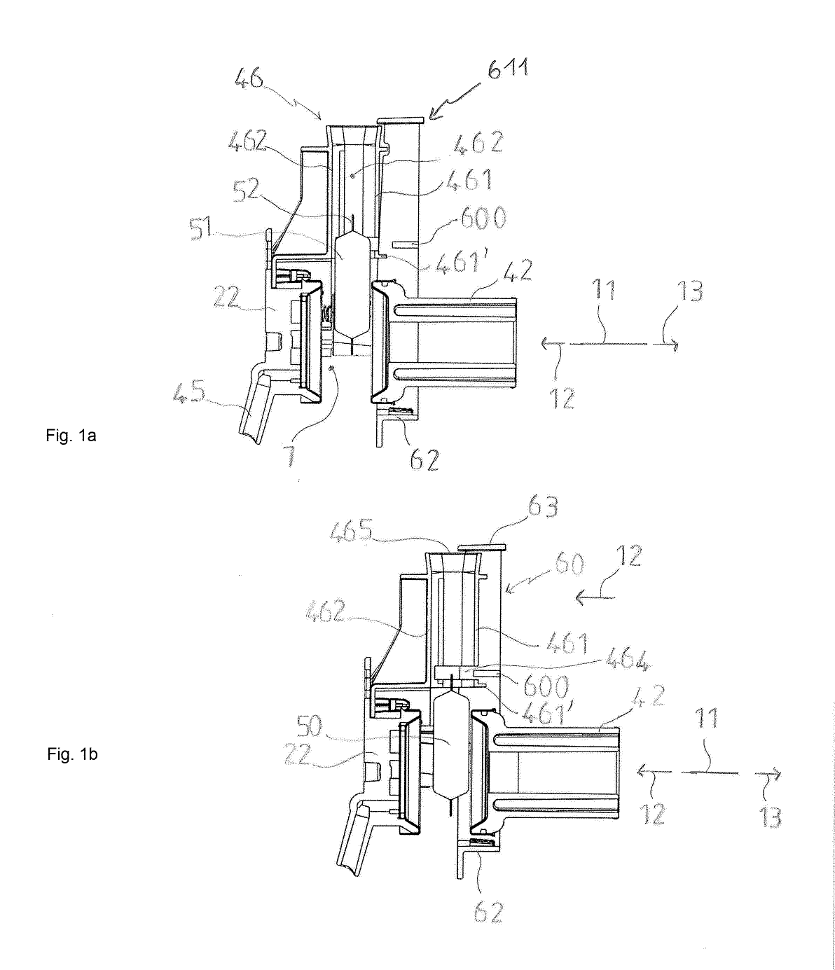

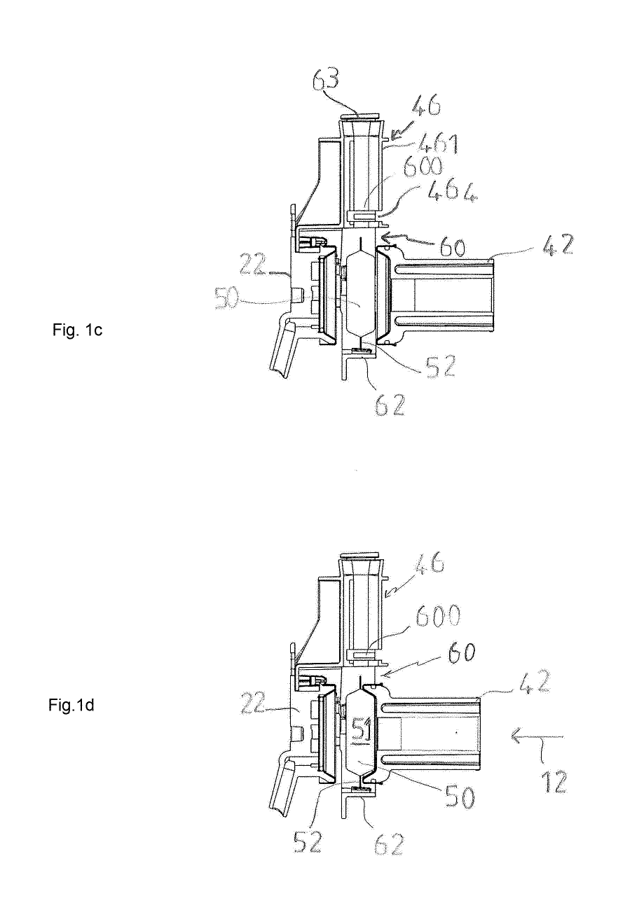

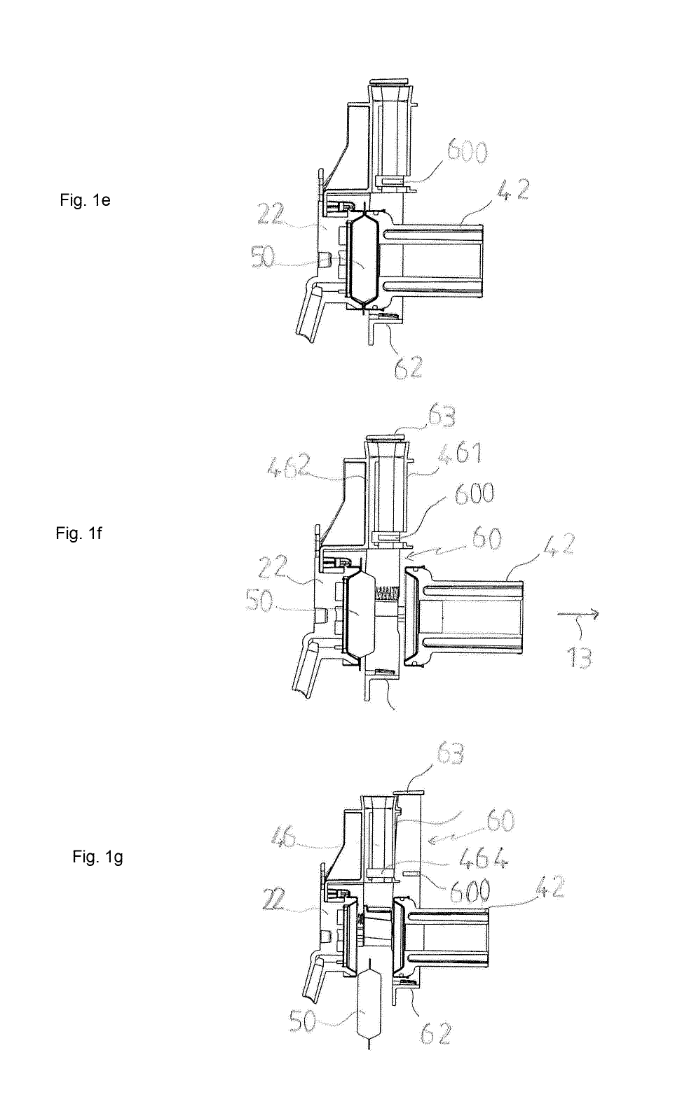

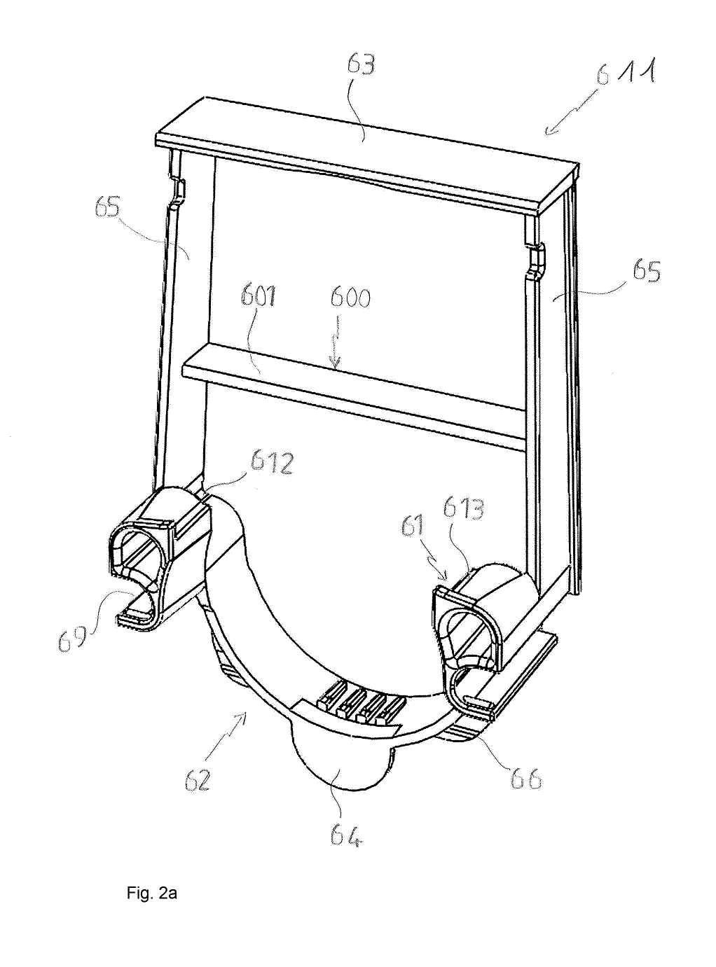

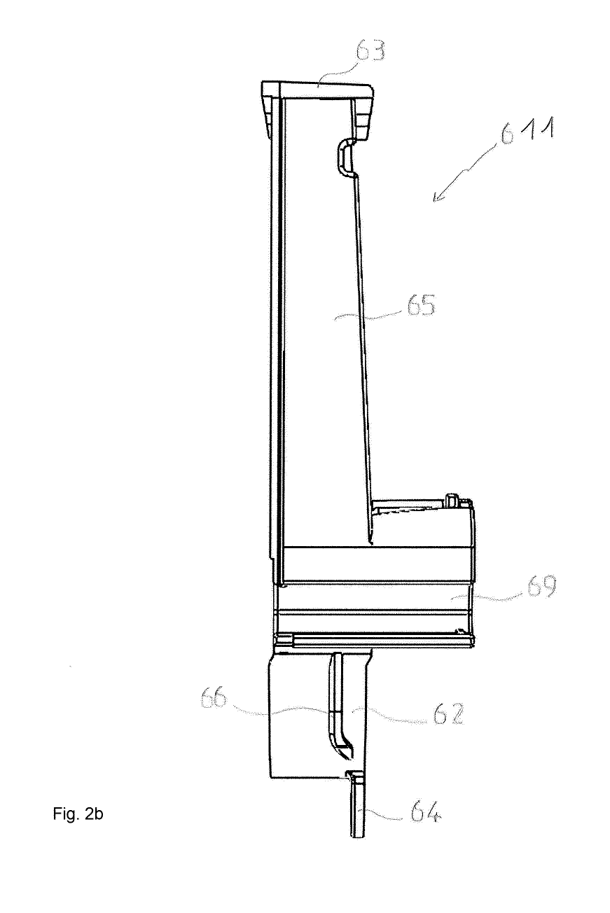

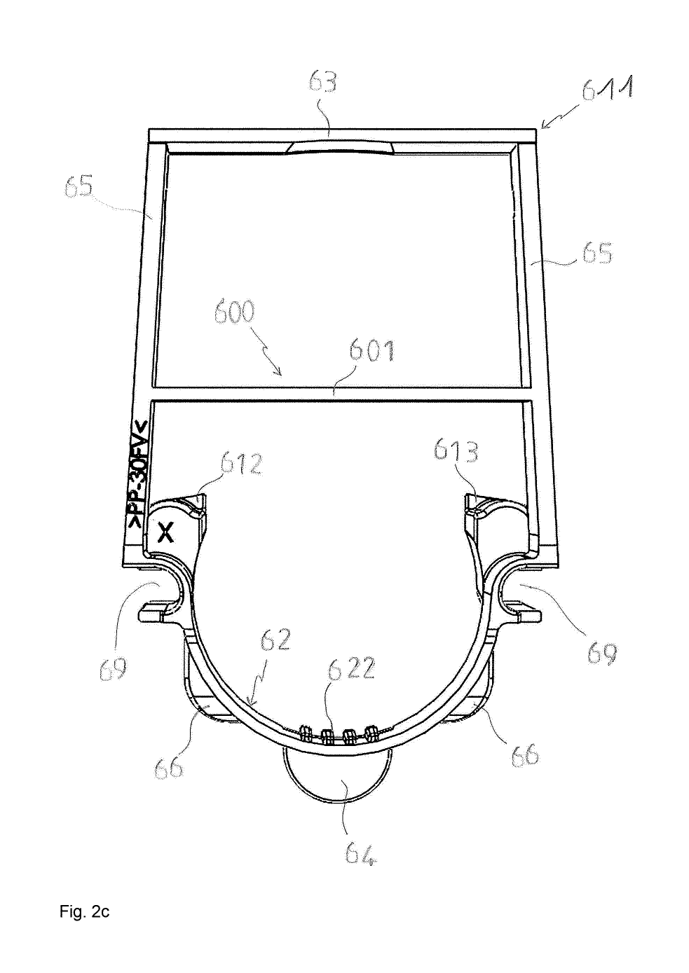

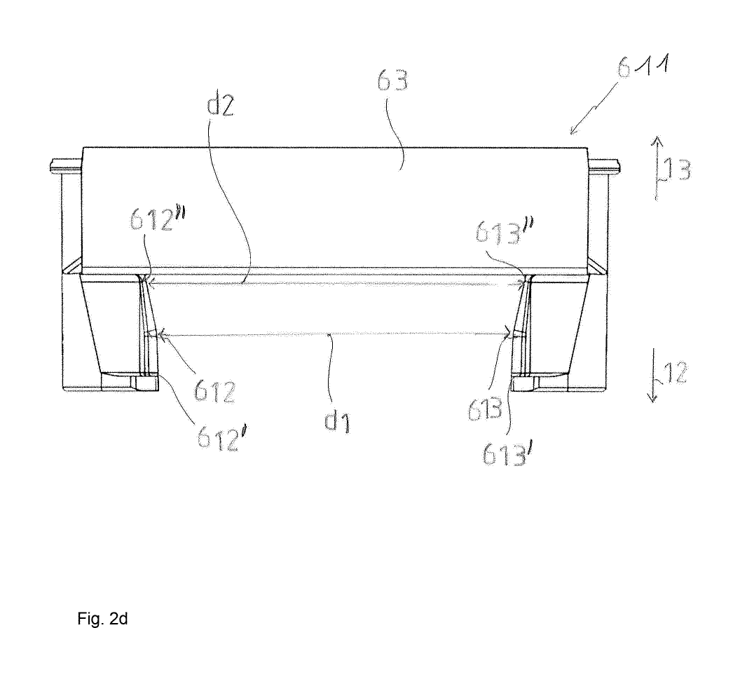

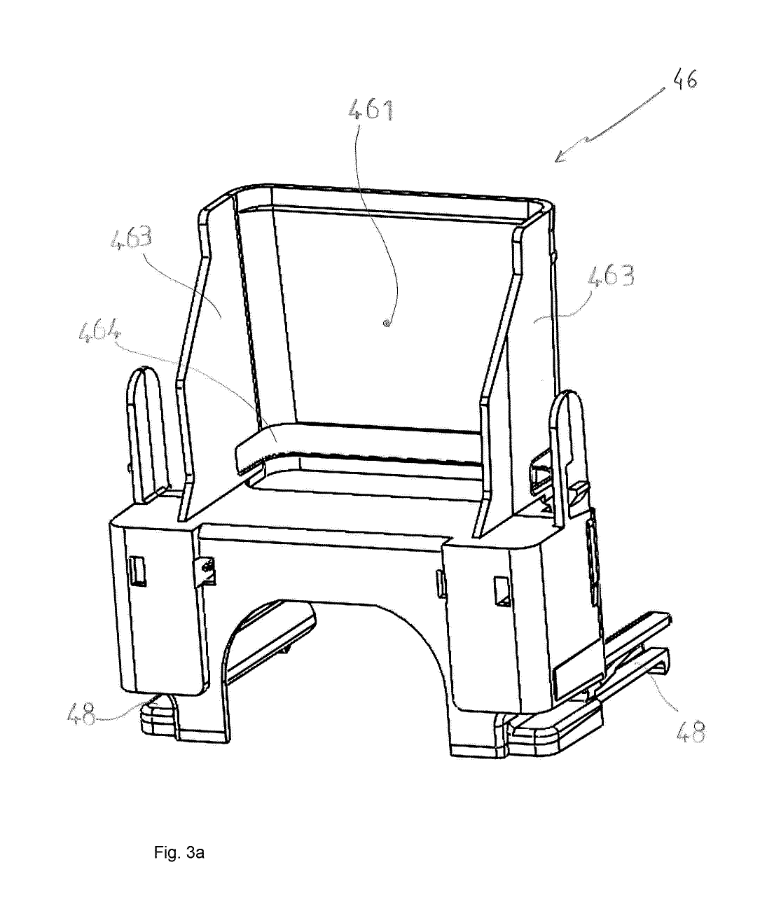

In reference to FIGS. 1a to 1g, a system 10 for preparing a drink according to the invention has been illustrated.

Upstream and downstream refer to the portions of space positioned before and after, respectively, a point considered in relation to the normal trajectory of a package in the machine during a cycle of preparing a drink.

In the context of the present invention, packages 50 containing a product to be infused, for example ground coffee, can be used. The product to be infused is contained in a closed inner volume 51 of the package. The inner volume is configured in order for a liquid such as water to be able to pass through said inner volume during the infusion. It is for example defined by filtering cloths or by a wall made of a material that is impermeable but made filtering via perforation. The package comprises a contour 52. Preferably, the closed volume 51 containing the product to be infused has axial symmetry and the contour 52 is in a plane perpendicular to the axis of symmetry.

In a non-limiting way, the volume 51 containing the product to be infused is formed by the assembly of layers joined via their edges at a supporting frame defining a peripheral contour 52. Advantageously, the present invention can be used with various types of packages. In particular, it does not require that the contour of the package be rigid. It applies to the packages having an outer envelope that is flexible, such as a dose, or rigid, such as a capsule, and more generally to any type of single-use package of product to be infused. It also applies to the packages, the outer envelope of which is suitable for at least partially disappearing during the infusion, via dissolution for example. It also applies to packages formed by a product to be infused aggregated by a binder and/or by the application of a pressure. Such a package formed by an aggregate of product to be infused such as coffee can be formed outside of the machine or be formed by a dedicated module of the machine.

The system 10 according to the invention comprises an infusion chamber 7 intended to receive a package 50. The chamber 7 comprises two portions of chambers arranged to be moved away from or closer to each other by an actuator in order to close or open, respectively, the infusion chamber 7.

Half chambers refer to parts suitable for being positioned in contact with each other or in contact with a package 50 in order to form an impermeable volume acting as an infusion chamber 7. The invention does not in any way imply that the two chamber portions have any kind of mutual symmetry.

In the embodiment presented, one of the chamber portions, designated first chamber portion 42 or mobile portion, is carried by an actuator allowing the chamber portions to be moved closer together and further apart. The other chamber portion, designated hereinafter as second chamber portion or stationary portion 22, is rigidly connected to a frame of the machine. Each of the chamber portions has an end defining a contour contained in a plane substantially perpendicular to the longitudinal axis 11.

Hereinafter, longitudinal axis 11 or longitudinal direction 11 refers to the direction comprising the main direction of the actuator. Forward direction 12 refers to the direction, along this longitudinal axis 11, that contributes to bringing the two chamber portions closer together and backwards direction 13 refers to the direction, along this longitudinal axis 11, allowing the two chamber portions to be moved away from each other. The longitudinal direction 11, the front direction 12 and the rear direction 13 are shown in FIG. 1a.

According to a non-limiting embodiment, the first chamber portion 42 has a supply duct connected to means for supplying a fluid to be infused, typically hot water. Conventionally, the supply means form a hot-water circuit comprising a tank, a boiler allowing the temperature of the water of the tank to be raised to a desired temperature for its infusion in the chamber 7, and a pump allowing the pressure of the water in the circuit to be increased. During the infusion, the two chamber portions 42, 22 are maintained firmly in contact with each other and define an impermeable volume for receiving the package 50. The impermeability can be created by pressing the contours of the two chamber portions against the contour of the package 50 that thus acts as a gasket. The impermeability can also be achieved or reinforced of the added sealing means.

The second chamber portion 22 comprises a drink-evacuation duct 45 in fluid communication with the inside of the infusion chamber 7 and with a drink outlet. This evacuation duct 45 is intended to evacuate the drink resulting from the infusion of the package 50, to a container such as a coffee cup.

After infusion, when the first chamber portion 42 is moved away from the second chamber portion 22, the infusion chamber 7 is opened, the package 50 already infused is thus no longer grasped in the chamber 7. This package 50 is evacuated from the chamber 7 via gravity and falls into a collection tank.

In a particularly advantageous but non-limiting way, the system is configured in such a way that the means for supplying fluid to the chamber 7 and the actuator of the chamber 7 are positioned on the same side of the chamber 7. Even more advantageously, the supply means and the actuator are positioned behind the chamber 7.

Thus, no member for supplying the chamber or for actuation should be positioned in front of the second portion 22. This allows the distance separating the cup from the chamber 7 to be shortened. The thermal losses during the transportation of the drink are thus reduced, thus improving the quality of the drink obtained. Moreover, the repetitiveness of the quality is improved since the losses during the transportation of the drink only slightly different according to the use of the machine. Furthermore, the size of the machine is reduced.

Preferably, the actuator driving the first chamber portion 42 is a cylinder. The cylinder comprises a piston. The first chamber portion 42 is carried by the piston of the cylinder. The cylinder is supplied with pressurized fluid by the pump. The system comprises means for returning the cylinder, comprising a return spring configured to carry out the return of the piston backwards 13 into the retracted position when the pressure decreases in the thrust chamber of the cylinder.

According to another embodiment, the first chamber portion 42 is a manual actuator, which can be actuated by the user. This can be, for example, a lever rotatably mounted on the frame of the machine and having a handle that can be actuated by the user. For example, the system can comprise a knee joint for transforming the rotation of the lever into a translation of the first chamber portion 42.

First 611 and Second 46 Part

The system 10 also comprises a first part 611 forming a closing device 60. This closing device 60 comprises upstream closing means 61 also designated upstream closing element. It is distinct from each of the chamber portions 22, 42 forming the infusion chamber 7.

The upstream closing means 61 are arranged in such a way as to act as a retractable stop. They are positioned upstream of the infusion chamber 7.

In a non-retracted position, the upstream closing means 61 prevent a package 50 from accessing its infusion position in the infusion chamber 7.

In this non-retracted position, the upstream closing means 61 also ensure the reception of and participate in maintaining a package 50 introduced into the system 10 in position. When it is maintained by the upstream closing means 61, the package is in a position called retention position. It rests on a support zone 612, 613 that will be described in more detail below.

Said support zone 612, 613 is configured to receive the package in the infusion position. It forms a gravitational stop for the latter when the latter is introduced into the system. According to one embodiment, said support zone 612 is not located facing the two half-chambers 22, 42. It is located outside of a volume defined by the two half-chambers 22, 42 and occupied by the two half-chambers 22, 42 during their movement. Thus, the package, when it is in the retention position, is located outside of this volume. Said support zone 612 is not located between the two half-chambers 22, 42 in a direction corresponding to the direction of translation of the two half-chambers 22, 42 or to the median plane. Thus, the support zone 612 is positioned with respect to the two half-chambers 22, 42 in such a way as to be outside of the trajectory followed by these two half chambers during their relative movement for closing the infusion chamber.

In the retracted position, the upstream closing means 61 allow the introduction of a package 50 into the chamber 7 from upstream of the latter.

According to the embodiment illustrated, but only optionally, the closing device 60 comprises downstream closing means 62, also designated downstream closing element. The downstream closing means 62 are positioned downstream of the infusion chamber 7. They are arranged in such a way as to act as a retractable stop for a package 50 introduced into the chamber 7.

In a non-retracted position, the downstream closing means 62 receive a package 50 introduced into the chamber 7 while the latter is open, and prevent the ejection, via gravity, of this package 50 to downstream of the chamber 7. The package 50 is received by a receiving surface 622 carried by the downstream closing means 62.

In this position, the downstream closing means 62 also prevent any intrusion into the chamber 7 from downstream of the latter. Thus, the user cannot, for example, insert the fingers of the user into the chamber 7.

In a retracted position, the downstream closing means 62 do not form a stop for a package 50 introduced into the chamber 7 and thus allow the evacuation of a package 50, preferably via gravity, when the chamber 7 is opened.

The infusion chamber is defined as the portion of space defined by the two half-chambers 22, 42 during their relative movement or when they are in contact with one another in order to carry out the infusion. Thus, the mobile half-chamber moves in the infusion chamber during its movement. Thus, the infusion chamber can be open or closed.

In the open position of the infusion chamber, if the package 50 is retained by the support zone 612, said zone is then located, preferably entirely, outside of the infusion chamber 7. In the open position of the infusion chamber, if the package 50 is retained by the receiving surface 622 carried by the downstream closing means 62, said surface is then located in the infusion chamber 7.

The system 10 is arranged in such a way as to make the closing device 60 go alternately from a first position in which the upstream closing means 61 prevent a package 50 from entirely entering the chamber 7, and the downstream closing means 62 ensure that no used package 50 remains present in the chamber 7, to a second position in which the upstream closing means 61 allow a package 50 to enter the chamber 7 and the downstream closing means 62 allow the reception and retention of a package 50 in the chamber 7 in the infusion position.

The closing device 60 is arranged in such a way that the position of the upstream closing means 61 determines the position of the downstream closing means 62 and the position of the downstream closing means 62 determines the position of the upstream closing means 61.

Thus, for a given position of the upstream closing means 61, the downstream closing means 62 only allow a single position and vice versa. The system thus functions sequentially.

The upstream closing means 61 and the downstream closing means 62 are rigidly connected. This feature contributes to simplifying the kinetics, improving the robustness, and limiting the cost and defectiveness rate of the system 10. The closing device 60 forming a single part thus defines a ring.

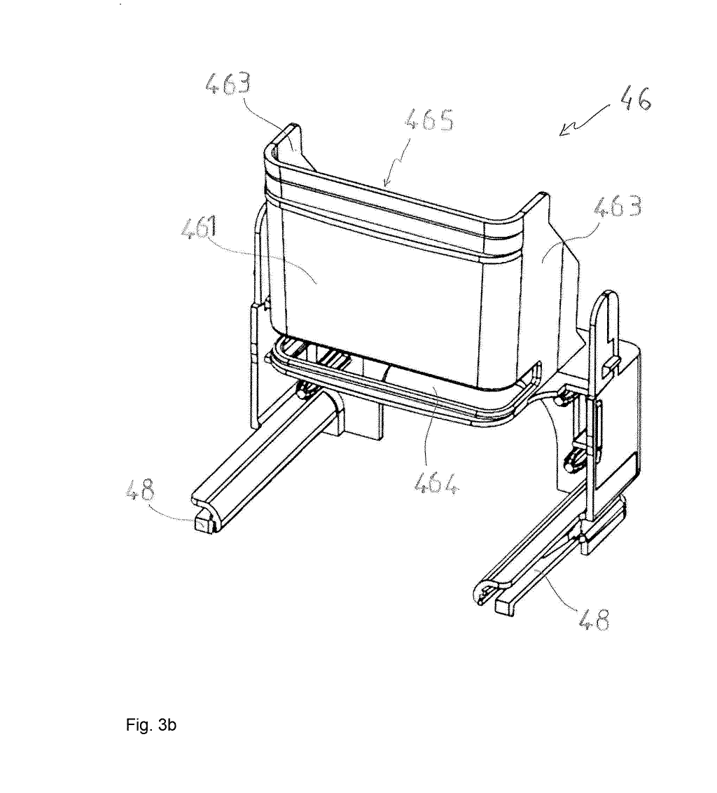

FIGS. 2a to 2d show the closing device 60 according to this example of an embodiment in detail. This closing device 60 comprises:
a guide member arranged to guide the closing device 60 in its alternating movement between the first position and the second position. Preferably, the guide member comprises two slides 69 suitable for guiding the closing device 60 in translation along two rails 48 extending along two guide axes parallel to the longitudinal axis 11 and which are preferably carried by a second part 46 which will be in detail below,
two arms 65, 65 each extending from a respective slide 69 and in a direction substantially perpendicular to the guide axis,
a shutter 63 extending transversely in order to join the two arms 65. The shutter advantageously forms an obstruction member, the function of which will be described below.
upstream closing means 61 arranged in such a way as to act as a stop for a package 50 upstream of the chamber 7 when the closing device 60 is positioned in the first position. Advantageously, the upstream closing means 61 comprise two support zones 612, 612 positioned on either side of a median plane of the package 50.
downstream closing means 62 arranged in such a way as to act as a stop for a package 50 downstream of the chamber 7 when the closing device 60 is positioned in the second position. Advantageously, the downstream closing means 62 are in the shape of a portion of a ring. They carry a centred surface 622 for receiving the package.

Moreover, the upstream 61 and downstream 62 closing means are positioned in such a way as to be mutually offset in the main direction of movement of the closing device 60. Thus, in the second position, the upstream closing means 61 are positioned substantially in front of the second chamber portion 22 and the downstream closing means 62 are positioned substantially behind the second chamber portion 22. In the first position, the upstream closing means 61 and the downstream closing means 62 are positioned substantially behind the second chamber portion 22.

The dimensions of this offset are chosen in such a way that:
when the closing device 60 is placed in the first position, the upstream closing means 61 prevent a package 50 from entirely entering the chamber 7, and the downstream closing means 62 allow the exit of a used package 50 out of the chamber 7,
when the closing device 60 is placed in the second position, the upstream closing means 61 allow the entry of a package 50 into the chamber 7, the downstream closing means 62 allow the reception and the retention of a package 50 introduced into the chamber 7.

Thus, in this example, since the closing device 60 is mounted and can slide on the longitudinal axis 11, the upstream 61 and downstream 62 closing means are mutually offset along the longitudinal axis 11. The upstream closing means 61 are positioned in front of the downstream closing means 62 along this same axis.

The system 10 comprises actuation means allowing alternation from the first to the second position. It is the same actuation means that act both on the upstream closing means 61 and on the downstream closing means 62.

The system 10 thus allows the risks of the packages becoming jammed to be considerably limited.

Since the number of actuators is reduced, the complexity of the structure of the system 10 is significantly limited as a result. This structure allows simplification of the kinematics of the members that allow alternation from the first to the second position.

At least one spacer spring, preferably working in compression, tends to push the closing device 60 towards the first position 42 of the chamber 7 and move the closing device 60 closer to the head of the cylinder. The spacer spring thus pushes the closing device 60 towards the rear 13.

The forward movement of the closing device 60 and the triggering of the movement of the closing device 60 in one or the other direction will be described in more detail below.

The closing device 60 is driven by a drive device not shown.

Preferably, as illustrated in FIGS. 2a to 2c, the closing device 60 comprises at least one and preferably at least two portions 66 forming stops. The portion 66 is used to couple the first part 611 with the mechanical drive device of said first part 611 supported by the stationary portion of the infusion module of the machine. Drive pins, not shown and belonging to the drive device, are configured to bear on these two portions 66. During the cycles of preparing the drink, these pins drive the first part 611 in horizontal translation.

Preferably, the first part comprises two portions 66 spread out to each side of the axis of movement in order to form a stop pair.

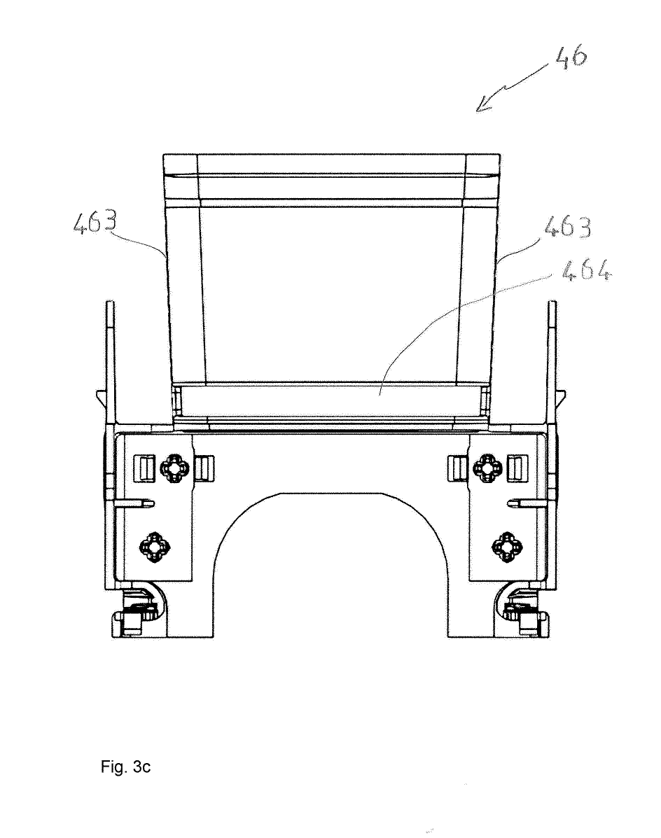

The system 10 also comprises a second part 46 forming guide means. This second part 46 is illustrated in detail in FIGS. 3a to 3d. This second part 46 has substantially the shape of a sleeve complementary to the shape of the cross-section of the package 50. It is configured to prevent any significant movement of the package 50 in a horizontal plane and to allow its vertical movement. They act as a hopper.

According to the embodiment illustrated, this second part 46 forming guide means is rigidly connected to the frame 20. It is therefore stationary. Preferably, it is mounted on the second chamber portion 22 or on a part rigidly connected to the latter or to the frame. They are arranged in such a way as to guide the package 50 upstream of the upstream closing means 61. They thus have two lateral guide surfaces 436 that limit the movement of the package in a plane perpendicular to the axis of translation 11.

Moreover, the guide means of this second part 46 are longitudinally positioned in such a way as to be positioned vertically in line with the opening of the chamber 7 in the second position in order to allow the introduction of a package 50 into the latter when the upstream closing means 61 are retracted. More specifically, they are positioned vertically in line with the downstream closing means 62 when the latter are in the second position. They thus guide the descent of the package 50 down into the chamber 7.

Moreover, they are vertically positioned in such a way as to be close enough to the upstream closing means 61 to maintain the package 50 in its retention position when the latter rests on the upstream closing means 61. Thus, when a package 50 rests on the upstream closing means 61 and the latter translate forward, the guide means contribute to preventing any significant longitudinal translation of the package 50. For this purpose, they have a bearing surface 462 forming a longitudinal stop configured to oppose the movement of the package 50. In the embodiment illustrated, the first part 611 comprising closing means 60 slides with respect to the second part 46, the bearing surface 462 thus blocks the sliding of the package 50 along the longitudinal axis 11. As indicated above, the second part 48 comprises rails 48 on which the slides 69 of the first part 611 slide.

Preferably and as illustrated in FIG. 1a, the second part 46 has another bearing surface 461 that faces the bearing surface 462 in order to maintain the package longitudinally towards the rear. Preferably, the bearing surfaces 461 and 462 are joined by portions forming, on either side of the sliding axis, two lateral-guide surfaces 463 for the package. The surfaces 461, 462 and 462 define an entry passage 465 for the package 50 and together form the hopper.

This second part 46 forming guide means is maintained opposite the opening of the infusion chamber 7 when the upstream closing means 61 are totally retracted. The relative movement of the closing device 60 and of the guide means thus allows the transfer of the package 50 from the upstream closing means 61 to the chamber 7. Moreover, this relative movement allows the integrity of the package 50 to be protected during this transfer. This guiding of the package is clearly illustrated in FIG. 1a to 1 to 1g.

In a non-illustrated alternative embodiment in which the second part 46 slides with respect to the stationary closing means 60, the bearing surface 462 pushes the package along the longitudinal axis 11 and makes it slide on the part 661 forming the upstream closing means 61.

These guide means allow a package 50 resting on the upstream closing means 61 to be maintained in position so as to facilitate the placement of this package 50 in the chamber 7. Optionally, the guide means have two substantially parallel vertical grooves defined by the surfaces 463 and intended to cooperate with the contour of the package 50 in order to improve the guiding of the latter.

Hatch

The system 10 also comprises a hatch defining an opening positioned upstream of the upstream closing means 61 and upstream of the guide means 46. The opening of the hatch is positioned longitudinally in such a way as to be located vertically in line with the guide means 46. They are thus positioned vertically in line with the upstream closing means 61 when the closing device 60 is positioned in the first position. The opening defined by the hatch can be accessed by a user and is intended to receive a package 50 for its introduction into the system 10.

Since the guide means are stationary with respect to the hatch, the invention eliminates any risk of a package or any other object such as a finger becoming jammed between the guide means and the hatch.

The shutter 63 of the closing device 60 forms an obstruction member arranged in such a way as to:
obstruct the opening of the hatch when the closing device 60 is positioned in the second position,
leave the opening of the hatch free when the closing device 60 is positioned in the first position.

Advantageously, the closing device 60 is formed from a single one-piece part. The closing device 60 can for example be made from aluminium, from stainless steel or from plastic.

Member for Detecting the Jammed Packages

Particularly advantageously, the first part 611 comprises a detection member 600 configured to be stopped by a package 50′ that has not fallen via gravity into the infusion chamber 7 when the upstream closing means 61 free the inlet of the infusion chamber 7.

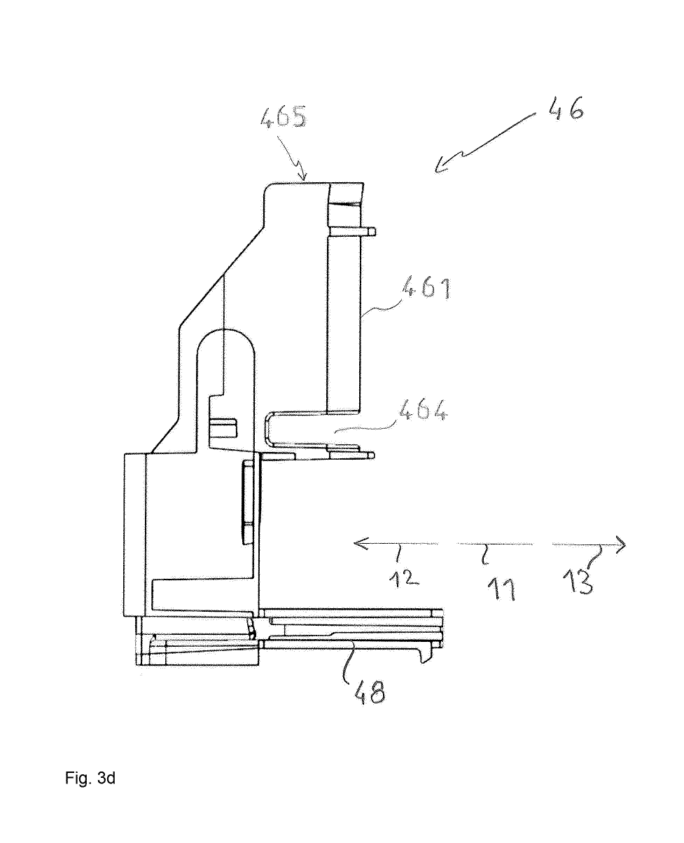

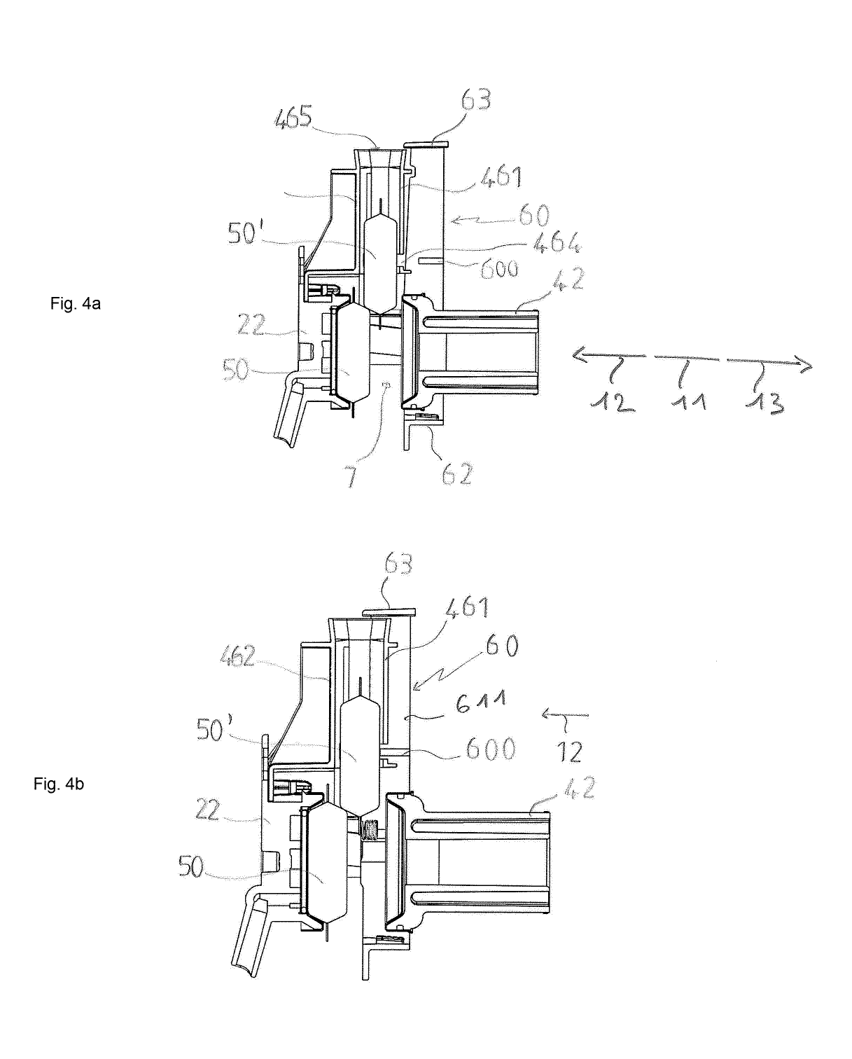

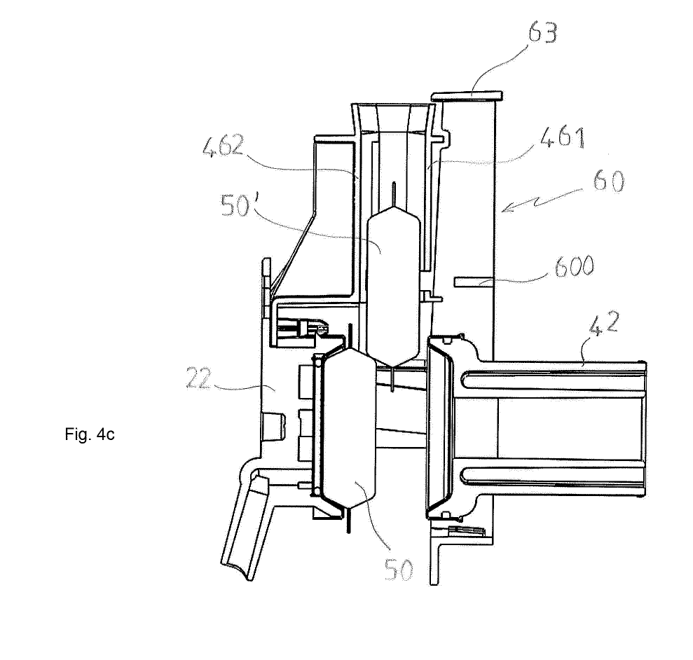

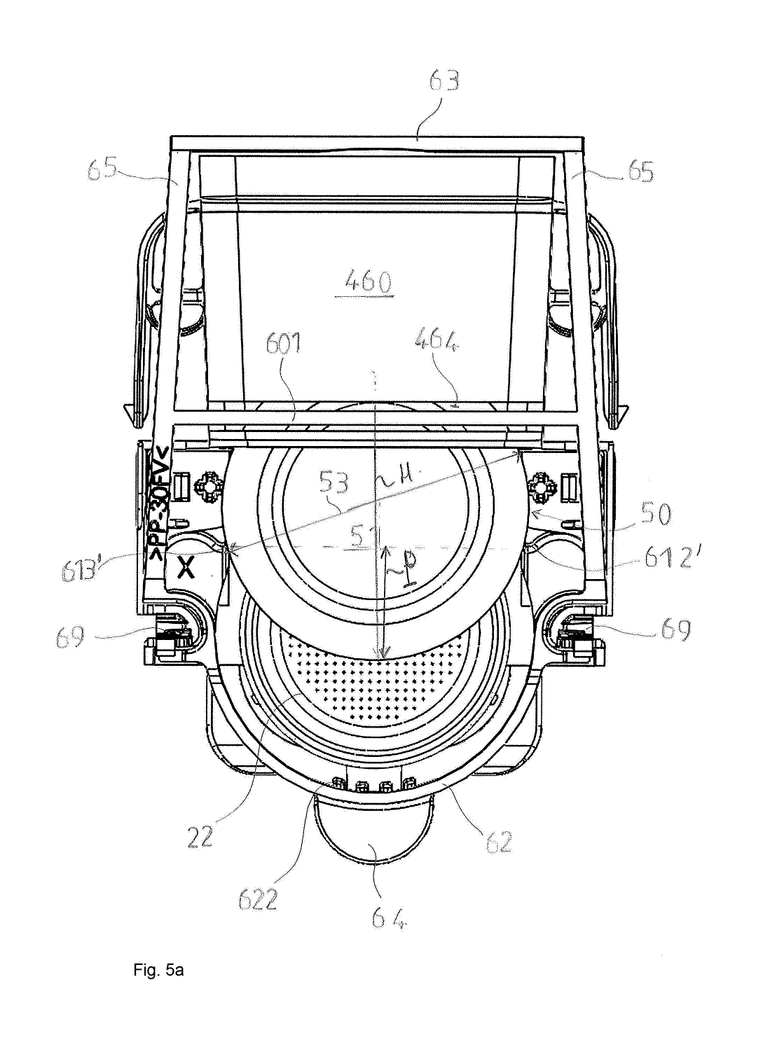

For example, a package 50′ can remain blocked in its retention position or between the retention position and its infusion position if another package 50 previously inserted into the machine was not ejected after infusion. This can occur in particular because of the pressing that occurs during the infusion between one of the portions 22, 42 of the infusion chamber 7 and the package 50. Such a case is illustrated in FIGS. 4a to 4c that will be described in more detail below.

The member 600 for detecting the presence of a package 50′ not transferred to the infusion chamber 7 moves, during the forward movement of the first part 611, in such a way as to sweep through at least a portion of the portion of space in which a package 50 is maintained in its normal retention position. Thus, typically, the detection member 600 is vertically positioned above the zones 612, 613 for supporting the package 50 in its normal retention position. This portion of space configured to be occupied by the package 50 in its retention position is defined by the first part 611 and second part 46.

The detection member 600 is moreover positioned farther to the rear 13 than the support zones 612, 613 along the longitudinal axis 11.

The detection member 600 does not penetrate said portion of space when the first part 611 is in the first position. Thus, the detection member 600 does not enter into contact with the package when the first part 611 is in the first position.

However, it penetrates said portion of space when passing from the first position to the second position. For this, it penetrates the second part 46.

For this purpose, the second part 46 advantageously has an opening 464 for the passage of the detection member 600.

Preferably, this opening 464 is formed in the wall of the bearing surface 461 partly forming the hopper. This opening 464 is clearly visible in FIGS. 3a to 3d.

Preferably, and as illustrated in FIGS. 3a and 3c, the detection member 600 is formed by a shutter 601 extending from one arm 65, 65 to the other. This allows the detection member 600 to sweep the entire transverse dimension of the space in which a package 50′ may become jammed.

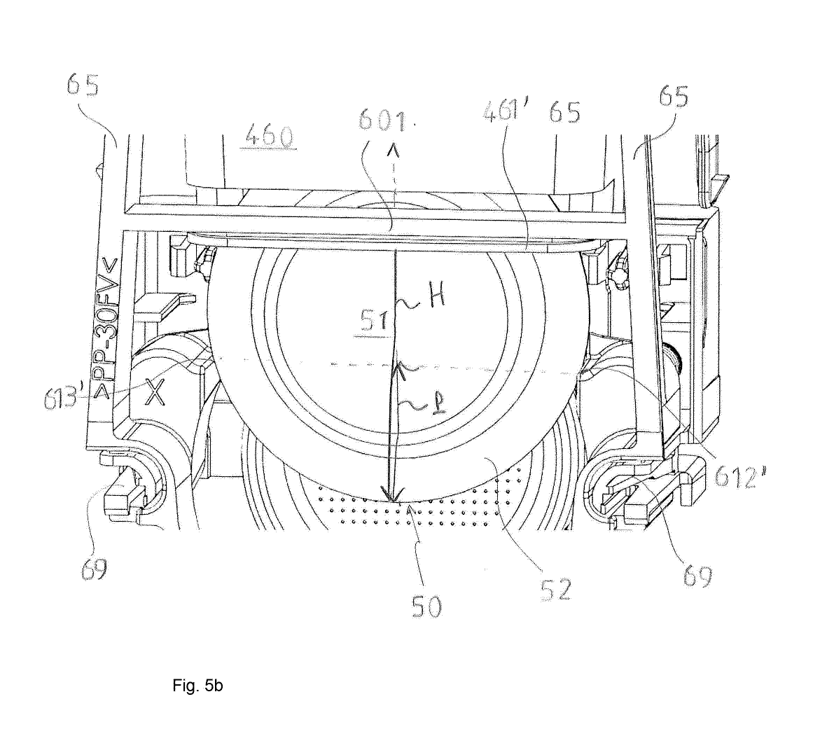

Preferably, the detection member 600 and the opening 464 have complementary shapes as is shown in FIGS. 1c, 5a and 5b, for example.

The invention is not limited to the shapes of the detection member 600 and of the opening 464 illustrated in the drawings.

If no package 50 remains blocked between its retention position and its infusion position during the forward movement of the first part 611, the detection member 600 is not stopped by any element and allows the first part 611 to reach the second position.

The system is configured in such a way that the cycle of preparing the drink is only continued if the first part 611 effectively reaches the second position. A presence sensor or a microswitch actuated by the first part 611 when it arrives in the second position can for example be provided in order to signal the correct positioning of the first part to a management module of the system.

If this switch or this presence sensor signals the positioning of the first part 611 in the second position, then the management module allows the cycle to be continued, including, for example:
the activation of the actuator, such as a pump, in order to move the mobile portion 42 of the infusion chamber 7.
the activation of the pump in order to bring the hot water from the boiler to the infusion chamber 7.

However, if after a predetermined time after the start of the forward movement of the first part 611, this part is not detected in the second position, the management module deduces therefrom that the detection member 600 has been stopped by a package and that the latter is jammed. In this case, the management module can trigger one or more of the following actions:
movement of the first part 611 towards the rear. Thus, the first part 611 and second part 43 move away from each other. The user or an operator can then access the jammed package 50′ in order to remove it from the machine;
placing the pump in standby or turning off the pump;
placing the boiler in standby or turning off the boiler;
sending an error signal, for example to the user or to a reception module remote from the machine, in order to signal this malfunction. For example, this signal can be a light signal or an instruction displayed on a screen carried by the machine;
placing the machine in standby or turning off the machine.

The invention thus allows the reliability of this type of machine to be considerably improved, namely when a package 50′ remains blocked because of the presence of another package 50 that has not been suitably ejected after infusion.

Support zones in the retention position

Advantageously, the support zones 6112, 613 on which the package 50 rests in its retention position are shaped in such a way as to have a spacing that increases towards the rear of the first part 611.

Thus, in a first portion extending longitudinally along the axis of translation 11, the distance between the support zones 612 and 613 is less than or equal to d1. d1 is illustrated in FIG. 2d. The front ends 612′, 613′ of the support zones 6112, 613 are separated by the distance d1.

The distance d1 is less than the maximum dimension of the package 50 taken horizontally in a vertical plane containing the two support zones 612, 613 at the location of their the bearing with the package 50. Thus, the package cannot fall via gravity between the two support zones 612, 613.

In a second portion that extends longitudinally along the axis of translation 11 and is placed behind the first portion, the distance between the support zones 612 and 613 increases and is greater than d1. The longitudinal ends of the support zones, labelled 612″ and 613″, are thus separated by a distance d2 illustrated in FIG. 2d.

The distance d2 is greater than the maximum dimension Dmax of the package taken horizontally in a vertical plane containing the two support zones 612, 613 at the location of their the bearing with the package 50. Thus, the package 50 can pass between the two support zones 612, 613 and fall via gravity. For this purpose, an opening is provided between the two support zones 612, 613 in order for the package 50 to be able to fall via gravity.

Thus, d1<Dmax and d2>Dmax. Preferably, d2>1.05 d1.

Preferably, the package 50 has a rounded shape at least on its contour in contact with the support zones 612, 613. Preferably, it has a circular contour, the centre of which is vertically located above the support zones 612, 613, the latter being located on either side of a vertical straight line passing through the centre of the contour. In this case, d1 and d2 are respectively less than and greater than the diameter 53 of the contour 52.

This structure of the support zones allows the package 50 to being its descent when the first part 611 has begun its movement but before the support zones 612, 613 have been totally retracted with regard to the package 50. In other words, the package 50, which remains substantially stationary since it is maintained by the second part 46 during the movement of the first part 611, slides on the support zones 612, 613 and thus descends via gravity.

This has the advantage that the package moves more quickly from its retention position to its infusion position for the same movement of the first part 611. The stop member 600 is thus prevented from being stopped by a package 50 while the latter is descending into the infusion chamber 7 when said chamber is not obstructed by a blocked package. However, if a package 50′ is blocked by another package 50 jammed downstream, the detection member 600 is stopped very quickly by the package 50′, that is to say, shortly before the beginning of its movement from the first position of the first part 600.

FIGS. 5a and 5b illustrate an embodiment in which support zones 612, 613 of the first part 611 are shaped in such a way that a portion P of the height H of the package is located below its contact with the support zones 612, 613 when the first part 611 and second part 46 are positioned in the first position, and thus when the package 50 is in the retention position), with preferably P>0.15H, preferably P>0.2H, preferably P>0.3H, preferably P>0.4H, P and H being measured vertically. P and H are illustrated in FIGS. 5a and 5b. P and H are measured vertically through the centre of the package 50. In the example illustrated, P is approximately equal to 0.4H.

Thus, only a portion of the package 50 is vertically located under the support zones 612, 613 when the package 50 is in the retention position.

Preferably, only a portion of the package 50 is located in the infusion chamber 7 when the package 50 is in the retention position as illustrated in FIGS. 5a and 5b.

For this purpose, the support zones 612, 613 are vertically located sufficiently close to the infusion chamber for a package that rests on the support zones 612, 613 to be already partly in the infusion chamber.

Thus, before the beginning of the cycle, the package is already partly inserted into the infusion chamber. A portion of the package is facing each of the two chamber portions 22, 42 in a direction parallel to the axis 11.

Consequently, as soon as the forward movement of the first part 611 begins, the package 50, already partly in the infusion chamber 7, slides on the zones of stops 612, 613 until the space between the latter is sufficient for the package to fall via gravity.

There is therefore no risk of the detection member 600 being stopped by this package 50 if the infusion chamber is empty and available. However, if a dose previously inserted is jammed in the infusion chamber, the detection member 600 is stopped by the package 50′ inserted secondly. The infusion cycle is then stopped.

Contact Zone 64 for the Detection of Maximum Filling of the Tank for Used Packages and/or the Manual Actuation of the First Part 611

According to an advantageous optional embodiment, the first part 611c comprises a contact zone 64. This zone 64 is illustrated in FIGS. 2a-2c.

This zone can have one or, advantageously, a plurality of functions.

A first function that this zone 64 can have is to identify that the tank for used packages is full. The machine comprises a tank for packages configured to receive, preferably via gravity, the packages after they exit the infusion chamber 7, that is to say, when they have been infused and are used.

The tank for used packages is located under the infusion chamber. It is not illustrated in the drawings.

When the tank is full, the user must remove it from the machine in order to empty it.

If it is full and the user does not empty it, this can lead to jamming of the system when a subsequent package is introduced into the machine or during a subsequent cycle of preparing a drink. Such jamming can be difficult to unjam.

In order to prevent a complete cycle of preparing a drink from being carried out when the tank is already full, the contact zone 64 that is configured to come in contact with a used package positioned at the top of the pile of used packages present in the tank is provided.

The contact zone 64, during its movement, comes in contact with such a used package and thus blocks the movement of the first part 611.

The first part 611 cannot then reach the end of its trajectory and actuate its switch. The management module thus deduces therefrom that the first part 611 is blocked. The machine thus malfunctions.

Preferably, the contact zone 64 extends at least partly vertically downwards. This thus allows this zone 64 to bear against a used package before the latter comes in contact with the support zones or with a package carried by the first part 611 which could make the unjamming more difficult.

Thus, the shape of the contact zone 64 extending downwards allows the detection of a full tank for packages to be anticipated by placing the detection zone lower.

Preferably, this contact zone 64 forms a portion of a disc, such as a half-moon. The system is configured for at least a portion of the contact zone 64 to move inside the tank for packages during at least a portion of the movement of the first part 611 and preferably throughout the entire movement of the first part 611. Thus, the contact zone 64 allows early detection of the maximum filling of the tank.

Moreover, this contact zone 64 is configured to provide a significant surface area for bearing on the used packages, in order to avoid damaging them. This significant surface area locally reduces the stress exerted by the contact zone 64 on the used package during the forward movement of the first part 611. Said package is often very fragile after having been subjected to the infusion cycle. The shape of the contact zone 64, which has a solid surface, like a portion of a disc like in the non-limiting example illustrated, thus allows the risk of the package tearing during the forward movement of the first part 611 to be reduced. Other shapes of the contact zone can of course be provided without going beyond the context of the invention.

Finally, this contact zone can advantageously have another function. The system is configured to allow the gripping of the contact zone 64 by a the user in order to manually actuate the first part 611. Thus, the user can make a possible jammed package descend.

The contact zone 64 extends mainly in a plane.

This plane is preferably vertical. This plane advantageously has a surface area sufficient for being easily pushed or grasped by one or two fingers of a user. Preferably, this plane has a surface area greater than or equal to 0.5 cm² and preferably greater than or equal to 1 cm², and preferably of approximately 1.5 cm².

Cycle without a Jammed Package

In reference to FIGS. 1a to 1g, the main steps of an operating cycle without a jammed package will now be described.

The user inserts a package 50 into the opening of the hatch. This package 50 falls via gravity while being guided and while being maintained in a substantially vertical position by the guide means of the second part 46, typically by the guide surfaces 463, the bearing surfaces 461 and 462. The movement of this package 50 via gravity is interrupted by the support zones 162, 163 of the upstream closing means 61 positioned facing the opening of the hatch and the inlet passage 465 of the second part 46. These upstream closing means 61 prevent the package 50 from entirely entering the chamber 7. Said package cannot therefore reach its infusion position. Nevertheless, according to the non-limiting embodiment described above in reference to FIGS. 5a and 5b, a portion of the package 50 is preferably already present in the infusion chamber 7 when the package 50 is in this retention position. This phase is illustrated in FIGS. 1a and 1b.

In a subsequent step illustrated in FIG. 1b to 1g, the user controls the actuation of the closing device. The latter is then free to slide forwards under the effect of the drive device not shown acting on the portions 66,66 forming stops. During this movement, the upstream closing means 61 of the first part 611 move forward 12 and the guide means of the second part 46, attached to the frame, maintain the package 50 vertically in line with the opening of the chamber 7. As they move forward, the upstream closing means 61 free the opening of the chamber 7. More specifically, the distance separating the support zones 612, 613 on which the package 50 rests increases. This phase is illustrated in FIG. 1b.

During this phase, the detection member 600 penetrates the space in which the package 50 was located before its descent. The detection member 600 is not stopped by any package 50 and the forward movement of the first part 611 is not stopped.

Moreover, during this phase of forward movement of the first part 611, the downstream closing means 62 progressively obstruct the opening of the chamber 7 downstream of the latter. When the opening of the chamber 7, freed by the upstream closing means 61 is sufficiently large, the package 50 is entirely introduced into the chamber 7, via gravity, where it is received by the receiving surface 622 of the downstream closing means 62 forming a stop. The package is then in the infusion position. The first part 611 and second part 46 are in their second relative position. This phase is illustrated in FIG. 1c.

When the first part 611 has reached the second position, it activates a microswitch or a presence sensor and the management module can continue the cycle of preparing the drink.

Namely, the mobile portion 42 moves closer to the stationary portion 22 as illustrated in FIG. 1d, until the chamber is completely closed as illustrated in FIG. 1e.

This movement of the mobile portion 42 can be driven by a cylinder controlled by the management module or can be driven manually by the user.

Moreover, the management module controls the injection of the hot water into the infusion chamber 7.

Once the infusion is completed, the mobile portion 42 moves away from the stationary portion 22 as illustrated in FIG. 1f, until the infusion chamber 7 is opened. The drive device not shown and acting on the first part 611 allows the retraction of the latter towards the rear 13. The first part 611 returns to the first position allowing the freeing of the package 50 out of the chamber 1. This phase is illustrated in FIG. 1g.

The two portions 22, 42 in the shape of cups substantially guide the package 50 towards the opening of the chamber 7 when they move away from each other. The closing device 60 is brought into the first position: the downstream closing means 62 no longer hinder the ejection of the package 50 and the latter can then be evacuated towards the recovery tank of the chamber 7 via gravity. This phase is illustrated in FIG. 1g. Moreover, the obstruction shutter 63 leaves the opening of the hatch free and a new package 50 can be inserted into the system 10.

Advantageously, the operation of the invention provides improved repetitiveness of the quality of the drink obtained and greater reliability, since the risks of the mechanism jamming and the integrity of the package being degraded are reduced.

Cycle with a Jammed Package

In reference to figured 4a to 4c, the main steps of an operating cycle with a jammed package 50 will now be described.

FIG. 4a is identical to FIG. 1a, except for the fact that a first package 50, inserted before a second package 50, has remained jammed in the infusion chamber 7 after the previous cycle. For example, and as illustrated in FIG. 4a, this first package 50 remains pressed against one of the two chamber portions 22, 42 even after the opening of the infusion chamber 7 and the return of the first part 611 towards the rear 13. This is for example caused by the combination of the pressing stress of the two portions 22, 42 on the package 50 and the sticking effect caused by the humid interface between the stationary portion 22 and the package 50.

Thus, the second package 50′, inserted into the second part 46 forming a guide, is stopped by the first package 50 during its descent via gravity.

When the user triggers the cycle of preparing a drink, the first part 611, moves forwards 612 like for FIG. 4b. However, contrary to FIG. 4b, the detection member 600 is stopped by the second package 50′ that has not sufficiently descended because it is blocked by the first package 50 and stops the forward movement of the first part 611. The second package 50′ is effect still positioned facing the opening 464 when the detection member 600 penetrates through this opening 464.

The first part 611 cannot then finish its trajectory and reach the second relative position between the first part 611 and second part 46. The first part 611 cannot therefore actuate the end-of-trajectory switch or sensor. The management module thus understands, after a time, that the cycle of preparing the drink must be interrupted.

The management module thus ends the cycle of preparing the drink. Namely, it does not order the forward movement of the mobile portion 42 of the infusion chamber 7 and does not order the injection of pressurised hot water.

Advantageously, the management module orders the return of the first part 46 towards the rear 13 as illustrated in FIG. 4c

Preferably, the machine then malfunctions. It can, for example, send an alarm signal to the user. The user can manually evacuate the packages 50, 50′ jammed in the system.

The invention thus provides a robust and particularly effective solution for improving the reliability of the systems for producing a drink.

Numerous alternatives to the device described above can be provided without going beyond the context of the invention.

Namely, the closing device 60 can be arranged in such a way as to translate in a main direction different than that of the longitudinal axis 11, for example such as a horizontal main direction perpendicular to the longitudinal axis 11. For such a closing device 60, the upstream and downstream closing means of such a device are offset in this main direction.

The actuation of the closing device 60 is carried out by an electric motor or manually.

The adaptation of the system 10 described above to packages different from the one shown in the drawings can be carried out easily by modifying the dimensions and the configuration of the upstream and downstream closing means of the first part 611, of the guide means of the second part 46, of the opening of the hatch and of the two half chambers 22, 42.

The invention is not limited to the embodiments described but extends to any embodiment that falls within the scope of the claims.

The invention extends namely to the systems in which the first part 611 only comprises upstream closing means without downstream closing means. It also extends to the systems in which the position of the downstream closing means does not determine the position of the upstream closing means and vice versa.

The invention extends to the systems in which the channel for supplying the chamber can be carried by the mobile chamber. The invention also extends to the system in which the supply channel is carried by an element of the frame or by the stationary half-chamber 22.

In the example illustrated and described in detail, the guide means of the second part 46 are stationary with respect to the frame and the upstream closing means are mobile with respect to the frame.

The invention also extends to the systems in which the first part 611 is stationary with respect to the frame and the second part 46 and its guide means are mobile with respect to the frame. Thus, the bearing surface 462 of the second part 46 is mobile in translation. The bearing zones 612, 613 and the detection member 600 of the first part 611 are thus stationary and each form, for example, a rail on which the package 50 slides while being driven by the movement of the bearing surface 462 carried by the guide means 46.

The invention extends to any type of bearing surface 462.

The detection member 600 forming a stop can be formed by any type of member suitable for coming in contact with the package 50′ in order to oppose the axial sliding of the first part 611 if a jammed package is present.

REFERENCES

10. System
11. Longitudinal axis
12. Forward direction
13. Rearward direction
22. Stationary half-chamber
24. Inlet duct
42. Mobile half-chamber
45. Evacuation duct
46. Guide means
46. Second part
461. Bearing surface
462. Bearing surface
463. Lateral guide surface
464. Opening
465. Inlet passage
48. Rail
50. Package
50′. Package
51. Volume containing the product to be infused
52. Contour of the package
53. Diameter
60. Closing device
611. First part
61. Upstream closing means
612. Bearing zone
612′. Bearing zone
613. Bearing zone
613′. Bearing zone
62. Downstream closing means
622. Surface for receiving the package
63. Obstruction shutter
64. Contact zone for the detection of the maximum filling of the tank for
used packages and/or the manual actuation of the first part.
65. Arm
66. Stop
69. Slide
600. Detection member
7. Chamber

1. A system for producing a drink from a package comprising a product to be infused, the system comprising:
two half chambers together forming an infusion chamber inside which the package is intended to be infused when the package reaches an infusion position;
a first and a second part having relative mobility and partially defining at least one receiving assembly configured to receive the package before positioning the package in an infusion position inside the infusion chamber,
wherein, the first part comprises at least one support zone configured to stop, when the first and second part are in a first relative position, the movement of the package and come in contact with the package to support the package in a retention position preventing the package from reaching the infusion position; in their first relative position, the first and second part thus together define a portion of space configured to receive the package in the retention position;
wherein when the first and second part are in a second relative position, the at least one support zone frees the passage of the package that allows the latter to reach the infusion position;
wherein the system comprises a detection member rigidly connected to the first part and shaped in order to:
penetrate said portion of space configured to receive the package in its retention position during the relative movement of the first and second part and before the first and second part reach their second relative position;
be absent from said portion of space configured to receive the package in its retention position when the first and second part are in their first relative position.

2. The system according to claim 1, wherein the system comprises a switch configured to be actuated when the first and second part are in their second relative position and configured to interrupt the preparation of the drink if after a predetermined time the switch is not actuated.

3. The system according to claim 2, configured to bring back the first and second part or allow them to be manually brought back to their first relative position if after a predetermined time the switch is not actuated.

4. The system according to claim 1, comprising an actuator configured to bring the two half chambers together forming the infusion chamber closer together, the system being configured to actuate the actuator to bring the two half chambers closer together only if the first and second part are in their second relative position.

5. The system according to claim 1, comprising a pump configured to inject water hot water into the infusion chamber when the two half chambers are closed, the system being configured to actuate the pump only if the first part is in the second relative position.

6. The system according to claim 1, comprising a boiler configured to supply hot water to the infusion chamber, the system being configured to deactivate the operation of the boiler if after a predetermined time the first part has not reached the second relative position when a cycle of preparing a drink has been started.

7. The system according to claim 1, comprising an end-of-trajectory switch configured to be actuated when the first part is in the second position, the system being configured to detect that the first part is in the end-of-trajectory position when the first and second part are in their second relative position.

8. The system according to claim 1, wherein the second part comprises a bearing surface configured to maintain the package in position when the first part moves with respect to the second part.

9. The system according to claim 8, wherein the second part comprises a guide element carrying the bearing surface and arranged to guide the package during its descent via gravity in preparation for its reception on the first part.

10. The system according to claim 9, wherein the guide element is formed at least partly by an inner face of a hopper forming a guide for the package during its reception on the first part.

11. The system according to claim 8, wherein the second part comprises an opening configured to allow the passage of the detection member.

12. The system according to claim 1, wherein the detection member is formed by a shutter extending transversely to the direction of relative movement of the first and second part.

13. The system according to claim 1, wherein the at least one support zone forms a vertical stop, blocking the movement of the package under the effect of its weight.

14. The system according to claim 13, wherein the first part comprises at least two support zones located on either side of a median plane of the system.

15. The system according to claim 1, wherein the first part comprises at least two support zones, for a package in its retention position, the distance between the two support zones increasing in the direction of the rear of the first part, the front of the first part being taken in the direction of movement of the first part from the first position to the second position.

16. The system according to claim 1, wherein the first part has an opening between the support zones, in such a way that the package is able to fall via gravity through said opening between the support zones when the second part reaches the second relative position.

17. The system according to claim 1, comprising the package and wherein:
the distance d1 separating the two support zones at the package when the first part is in the first position is less than the dimension of the package in order to prevent the latter from passing between the two zones of support and
the distance d2 separating the two support zones at the package when the first part is in the second relative position is greater than the dimension of the package in order to allow the latter to fall via gravity between the two zones of support.

18. The system according to claim 1, comprising the package and wherein the support zones of the first part are shaped in such a way that a portion P of the height H of the package is located under its contact with the support zones when the first and second part are positioned in the first relative position.

19. The system according to claim 1, comprising the package and configured in such a way that a portion of the package is facing each of the two chamber portions in a horizontal direction when the first and second part are in the first relative position.

20. The system according to claim 1, wherein a portion P of a height H of the package is P>0.15H, P and H being measured vertically.

21. The system according to claim 1, wherein the first part comprises, at its lower end, at least one contact zone extending vertically downwards.

22. The system according to claim 21, wherein the contact zone forms a solid surface extending in a substantially vertical plane and the surface area of which is greater than 0.5 cm².

23. The system according to claim 21, comprising a tank for packages configured to collect the used packages after their infusion, wherein said at least one contact zone moves inside said tank during the movement of the first part.

24. The system according to claim 1, wherein said relative mobility between the first and second part is a relative mobility in translation.

25. The system according to claim 24, wherein the two half chambers accept relative mobility in translation along an axis parallel to the axis of relative translation of the first and second part.

26. The system according to claim 24, configured in such a way that at the end of sliding, the first part is retracted, at least partially under the second part in a vertical direction in such a way that the package is configured to move under the effect of gravity.

27. The system according to claim 1, wherein said relative mobility between the first and second part is a relative mobility in rotation.

28. The system according to claim 1, wherein the first and second part are mobile and stationary, respectively, with respect to a frame of the system.

29. The system according to claim 1, configured in such a way that when the first and second part translate from their first to their second relative position, the package passes via gravity from the retention position to the infusion position.

30. The system according to claim 1, wherein the support zones of the first part form upstream closing element arranged in such a way as to selectively prevent or allow the entry of the package into the infusion chamber according to the relative position of the first part with respect to the second part.

31. The system according to claim 1, wherein the first part comprises a receiving element, forming a downstream closing element and configured to:
when the first and second part are in their first relative position: stop the descent of the package from its retention position and maintain it in its infusion position inside an infusion chamber; and
when the first and second part are in their second relative position: allow the exit of the package out of the infusion chamber.

32. The system according to claim 1, further comprising the package.

33. The system according to claim 32, wherein the first part has at least two support zones positioned in contact with the package in the position for retention of the package, the first part and the package being shaped in such a way that:
when the first and second part are in their first relative position, the support zones form a stop preventing the descent of the package via gravity, the distance separating the two support zones being less than the dimension of the package at the two support zones; and
when the first and second part are in their second relative position, the support zones allow the descent of the package via gravity, the distance separating the two support zones being greater than the dimension of the package at the two support zones.

34. The machine for preparing a drink, comprising a system according to claim 1 and a boiler configured to heat a liquid intended to infuse the package.
